(19) United States
(12) Patent Application Publication
(10) Pub. No.: US 2010/0229029 A1
(43) Pub. Date: Sep. 9, 2010

(54) INDEPENDENT AND DYNAMIC CHECKPOINTING SYSTEM AND METHOD

(76) Inventor: Robert Claude Frazier, II, Raleigh, NC (US)

Correspondence Address: ERICSSON INC., 6300 LEGACY DRIVE, M/S EVR 1-C-11, PLANO, TX, 75024, US

(21) Appl. No.: 12/399,534

(22) Filed: Mar. 6, 2009

(51) Int. Cl. G06F 11/20; G06F 12/00; G06F 12/02

(52) U.S. Cl. 714/5; 711/154; 711/E12.001; 711/E12.002; 711/200; 714/E11.071

(57) ABSTRACT

A system and method of synchronizing a routing system having an active subsystem actively processing within the routing system and a standby subsystem. The method includes the steps of specifying an address or range of addresses of data to be synchronized within the routing system, detecting a write to main memory of the active subsystem, and comparing an address of the detected write to main memory of the active subsystem with the specified address or range of addresses. Next, the address and data of the detected write to main memory are stored in a First In First Out (FIFO) queue of the active subsystem if the address of the detected write to main memory matches the specified address or range of addresses. The address and data of the detected write to main memory are sent to the standby subsystem where the data and address are written to the main memory of the standby subsystem.

### BACKGROUND

The present invention relates to communications networks. More particularly, and not by way of limitation, the present invention is directed to a system and method of using an independent and dynamic checkpoint mechanism in a routing system.

In today's network systems, redundancy is a highly desirable feature to increase the availability of a system. High availability is crucial in minimizing the downtime of the various components in these network systems. Many of the existing networking products utilize a redundancy methodology whereby there is an active processor and a standby processor responsible for controlling the network component. When a failure is detected in the active processor, the standby processor takes over to process requests and forwarding of the requests. To further increase the availability, the standby processor preferably takes over control “hitlessly”, implying that there is no loss of sessions and forwarding continues during the failover. However, “hitless” does not explicitly indicate the amount of time necessary to perform the failover. In order to increase the availability of the system, decreasing the failure recovery time is essential. Systems with this active/standby topology can be configured to failover, in response to a failure detection, in three ways. In the first way, cold standby is used where the standby processor begins from its initial state. This is identical to a reboot of the active processor. This scenario recovers from a hardware failure on the active processor. In the second way, warm standby, the standby processor runs, but the state information of the system may be stale or invalid. The standby processor needs to “learn” the state of the system. The recovery time to full operation is less than the cold standby mode. In the third way, hot standby, the applications on the active processor maintain any state information necessary on the standby to take control immediately. This requires the applications requiring checkpointing to actively synchronize the standby resources to the active resources in real time. The recovery time to full operation in the mode is very small.

Availability is a function of the recovery time from a failure, whereby the smaller the recovery time, the higher the availability. Mathematically, this is represented in the following equation:

$$A = \frac{λ}{λ + μ}$$

where A is availability, λ is the Mean Time To Failure (MTTF), and μ is the Mean Time To Repair (MTTR). As can be seen from this equation, by reducing the mean time to repair, availability of the processor increases. Thus for a active/standby system configuration, the “hot” standby guarantees the highest availability. The present invention is related to this hot standby configuration.

For the “hot” standby configuration, the currently existing solutions for synchronization of state information onto the standby unit can be grouped into software and hardware methods. FIG. 1 is simplified block diagram illustrating software data mirroring and checkpointing in an existing system 10. The most commonly used synchronization methods use software as shown in FIG. 1. The system includes an active subsystem 12 having a processor 14 and a main memory 16. In addition, the system includes a standby subsystem 20 having a processor 22 and a main memory 24. A link 26 provides mirroring and checkpointing functions through an interconnection network 28. For this case, the active applications in the active subsystem 12 are required to synchronize with the standby subsystem 20. An example of this checkpointing is specified in the Service Availability Forum Application Interface Specification Checkpoint Service SAI-AIS-CKPT-B.02.02, Release 5.0. This agreement provides a facility for processes to record checkpoint data incrementally, which can be used to protect an application against failures. When recovering from fail-over or switch-over situations, the checkpoint data can be retrieved, and execution can be resumed from the state recorded before the failure.

However, there are several problems associated with using these software processes. First, the checkpointing mechanism is not independent from the normal processing. Each process records (e.g., synchronizes) checkpoint data to the standby subsystem for activation in case of a failover. This places a performance burden on the active process. If many processes in the system are checkpointing on a regular basis, performance degradation may be experienced. Second, changes in state data are lost if the active processor fails before checkpointing/synchronization with the standby is complete. In this situation, the standby processor gains control and begins operating on stale (i.e., outdated) state information. To minimize this problem, the standby processor would need to verify the checkpoint data before proceeding normal operation. This may result in the standby processor returning to its initial (restart) state in some cases. Consequently, this could increase the recovery time and decreases the availability of the subsystem.

In hardware methods, active applications do not have to explicitly checkpoint state information, but rather, uses the hardware to duplicate the received input information and send it to both the active and standby subsystems. FIG. 2 is a simplified block diagram illustrating hardware data mirroring in an existing system 50. The system includes an active subsystem 52 having a processor 54 and a main memory 56. The system also includes a standby subsystem 60 having a processor 62 and a main memory 64. The system also includes a duplicator 66. With this input replication hardware method, both the active and standby systems operates on the information as if they were both active, but the hardware only permits the true active subsystem to communicate with the outside world. However, the input replication systems also suffer from several problems. Unless there is a guarantee of delivery to the standby of the replicated input, the state information on the standby may be incorrect. In addition, since both active and standby subsystems operate on the same data, this method only protects the system against a hardware failure. Because the state of the standby software is the same as the active software, if the software caused the failure, the failure will also occur on the standby subsystem as well.

In another hardware assisted method, the hardware detects all writes to main memory on the active subsystem and copies the data to main memory on the standby subsystem. When the system detects a failure on the active subsystem, the standby subsystem assumes control. However, this hardware method also suffers from several disadvantages. The system writing to any memory location is synchronized to the standby and is not configurable. All writes to the main memory on the active subsystem is copied to the standby subsystem. This requires the memory addresses for the state data to be the same on both subsystems, which is not likely in a virtual operating system. Because the system is not configurable, all writes are copied to the system, yet not all writes are needed on the standby system, i.e., the operating system. Thus configuration is needed. In addition, this hardware method detects a failure and fails over to the standby systems, but does not address using the old active subsystem as the new standby subsystem when it is repaired. To be able to have a “backup”, the system must be restarted after failover. Information exchanged between the active and standby subsystem must be connected via hardware buses and co-located in the same chassis. Thus, this method is a tightly coupled system.

### SUMMARY

The present invention builds on the existing methods of achieving “hot” standby by defining an mechanism which independently synchronizes state changes of resources on an active processor (applications) to a standby processor(applications) and manages the checkpointing and failover of the active processor to the standby processor that is dynamically configurable.

In one aspect, the present invention is directed at a method of synchronizing a routing system having an active subsystem actively processing within the routing system and a standby subsystem. The method includes the steps of specifying an address or range of addresses of data to be synchronized within the routing system, detecting a write to main memory of the active subsystem, and comparing an address of the detected write to main memory of the active subsystem with the specified address or range of addresses. Next, the address and data of the detected write to main memory are stored in a First In First Out (FIFO) queue of the active subsystem if the address of the detected write to main memory matches the specified address or range of addresses. The address and data of the detected write to main memory are sent to the standby subsystem where the data and address are written to the main memory of the standby subsystem.

In another aspect, the present invention is directed at a system for synchronizing a routing system. The system includes an active subsystem actively processing within the routing system and a standby subsystem providing a backup for the active subsystem. The active subsystem stores a specified address or range of addresses of data to be synchronized within the routing system. The active subsystem also includes a Memory Write Detector for detecting a write to main memory of the active subsystem and comparing an address of the detected write to main memory of the active subsystem with the specified address or range of addresses. If the address of the detected write to main memory matches the specified address or range of addresses, the address and data is stored in a FIFO queue of the active subsystem. An active synchronization processor then reads the address and data stored in the FIFO queue, translates the stored address and data into a checkpoint message, and sends the checkpoint message to a standby synchronization processor in the standby subsystem. The standby subsystem then translates the received checkpoint message and writes the address and data from the translated checkpoint message to the main memory of the standby system.

In still another aspect, the present invention is directed at an active subsystem of a routing system for synchronizing the active subsystem with a standby subsystem backing up the active subsystem in a routing system. The active subsystem stores a specified address or range of addresses of data to be synchronized within the routing system. The active subsystem also detects any write to main memory of the active subsystem and compares the address of the detected write to main memory of the active subsystem with the specified address or range of addresses. If the address of the detected write to main memory matches the specified address or range of addresses, the address and data of the detected write to main memory are stored in a FIFO queue. The address and data of the detected write to main memory are then sent by a synchronization processor to the standby subsystem. The active subsystem may also translate the physical address of the write detected information to a virtual address which is defined as a region (base) plus a region offset. These translated virtual addresses may then be sent to the standby subsystem which translates the virtual addresses back to physical addresses by the standby subsystem.

### BRIEF DESCRIPTION OF THE DRAWINGS

In the following section, the invention will be described with reference to exemplary embodiments illustrated in the figures, in which:

FIG. 1 (prior art) is simplified block diagram illustrating software data mirroring and checkpointing in an existing system;

FIG. 2 (prior art) is a simplified block diagram illustrating hardware data mirroring in an existing system;

FIG. 3 is a simplified block diagram of a synchronization system in the preferred embodiment of the present invention;

FIG. 4 is a simplified block diagram of the active and standby system topology in the preferred embodiment of the present invention;

FIG. 5 is a signaling diagram illustrating the initialization process of the system;

FIG. 6 illustrates the contents of a memory write block in the preferred embodiment of the present invention;

FIGS. 7A and 7B are flow charts illustrating the steps of independently and dynamically checkpointing a routing system according to the teachings of the present invention; and

FIG. 8 is a signaling diagram illustrating the initialization process when the standby processor starts prior to the active processor in another embodiment of the present invention.

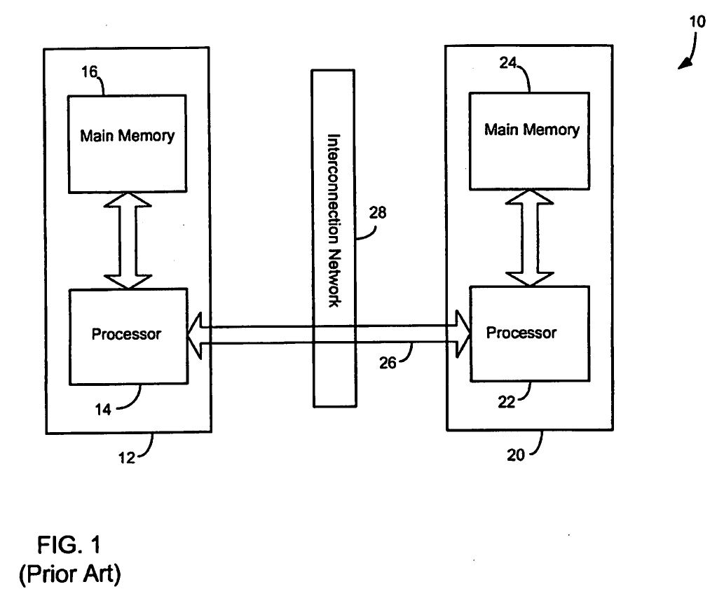

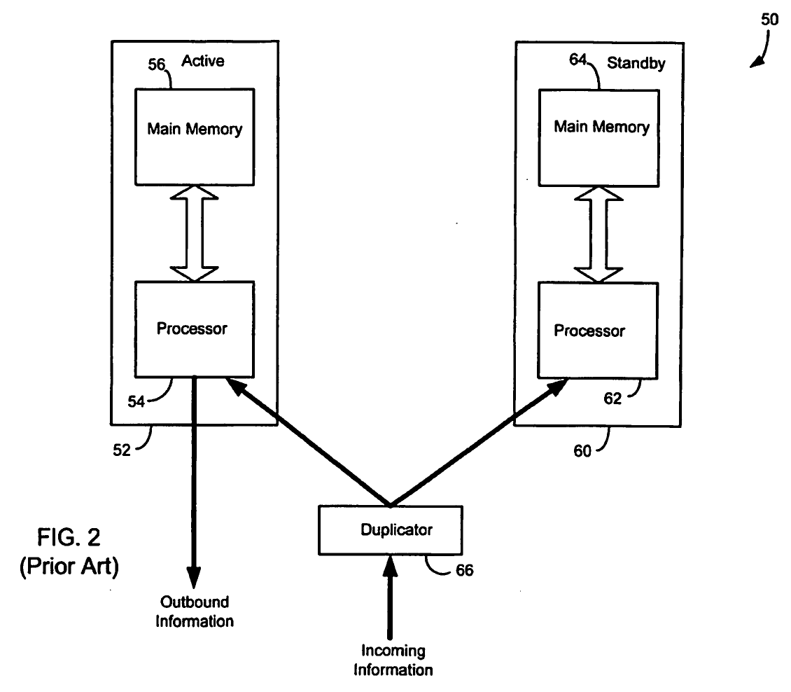

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

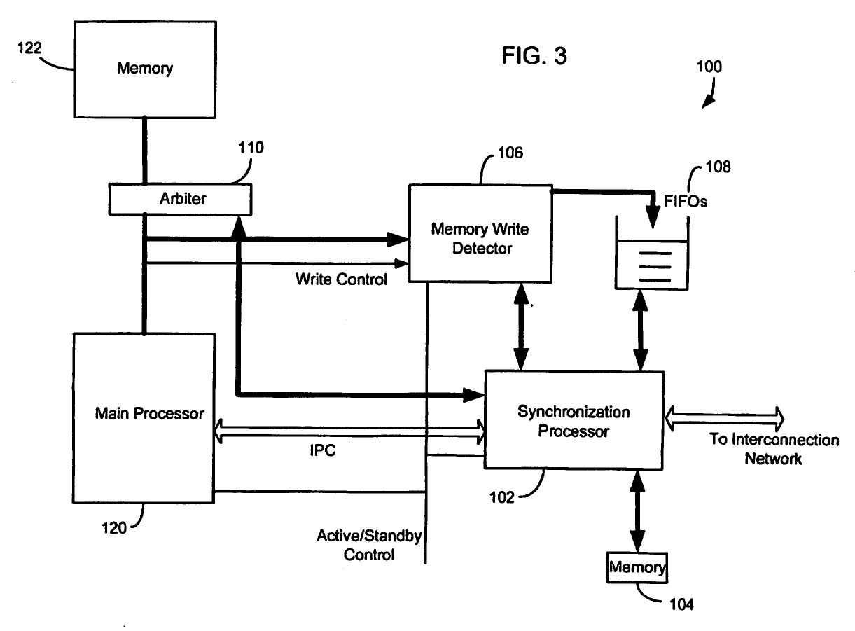

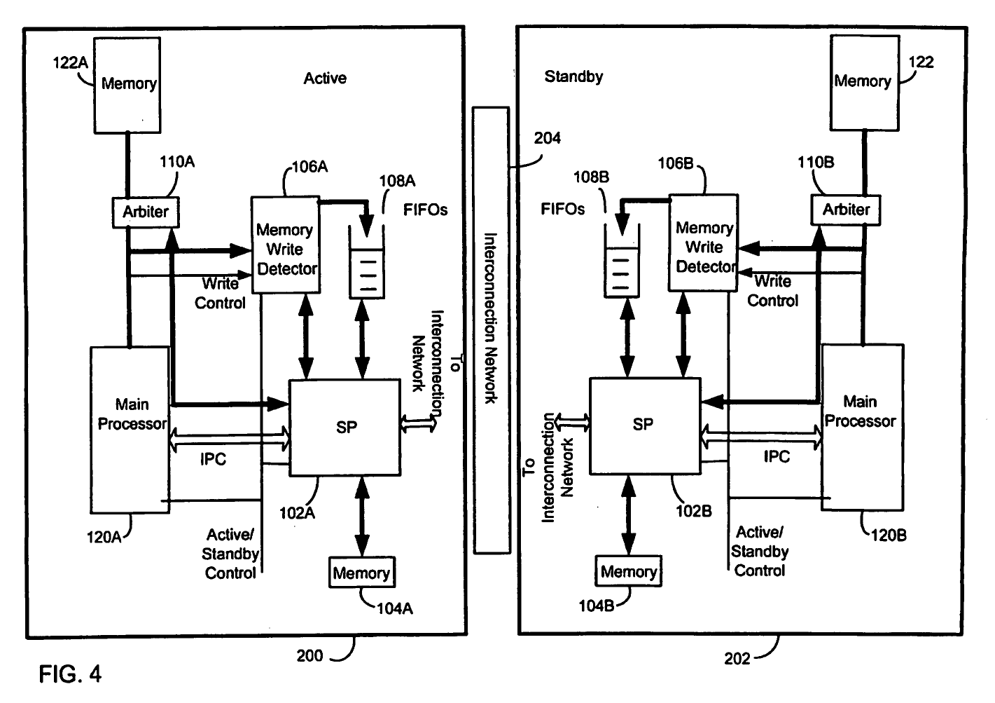

The present invention is a method and system for independently and dynamically synchronizing state changes on an active processor (applications) to a standby processor (applications) and manages the checkpointing and failover of the active processor to the standby processor. FIG. 3 is a simplified block diagram of a synchronization system 100 in the preferred embodiment of the present invention. The synchronization system 100 includes a Synchronization Processor (SP) 102 having a memory 104, a Memory Write Detector (MWD) 106, a First In First Out (FIFO) queue 108, and an arbiter 110. The synchronization system is integrated with a main processor 120 having a memory 122. FIG. 4 is a simplified block diagram of the active and standby system topology in the preferred embodiment of the present invention. An active subsystem 200 includes the synchronization system 100 having the SP 102A, the memory 104A, the MWD 106A, the FIFO queue 108A, and the arbiter 110A. The system also includes a standby subsystem 202 having the same components (listed as “B” components). The active subsystem and standby subsystem each communicate with an interconnection network 204.

The SP may be a general purpose processor. The SP provides the functions of configuring the checkpointing system, translating the checkpointed data, and communicating the checkpoint data with its peer SP. The SP preferably can operate in the role of an active SP or a backup SP. Depending on its role, the SP 102 performs several functions. For the active SP 102A, the SP communicates with the main processor 120A in the active subsystem 200 to define the memory ranges that the hardware will “snoop” for. The SP also programs the MWD 106A with the specified address ranges to monitor and establishes communications with its peer standby synchronization processor. In addition, the SP coordinates the checkpoint ranges that are to be monitored and reads data from the FIFO 108A written by the MWD 106A. Additionally, the SP translates the physical address of the write detected information to a virtual address which is defined as a region (base) plus a region offset. The SP 102A also transmits the memory writes detected by the memory write detector to the standby processor.

The standby SP 102B in the standby subsystem 202 also performs several functions, such as communicating with the main processor 120A in the active subsystem 200 to define the memory ranges that the hardware will “snoop” for. In addition, the standby SP turns off the MWD 106B on the standby subsystem 202 and establishes communications with its peer active SP 102A. In addition, the standby SP 102B coordinates the checkpoint ranges that are to be monitored and receives and processes the memory changes from the active processor. Additionally, the standby SP 102B translates the virtual address back to a physical address to store the write data in the main memory 122B.

The MWD 106 is a programmable device that “snoops” on the memory bus. When a write to main memory is detected, the MWD searches for a match to one of its programmed address ranges. If there is a “hit” (the address range is matched), the address and the data for the write event is stored in the FIFO queue 108 for the sync processor. The SP adds or deletes addresses to “snoop” for into the memory write detector. In addition, the FIFO queue 108 provides a buffer between the MWD 106 and the SP 102.

Because both the SP 102 and the main processor 120 can access main memory, an arbiter needs to be added to allow only one processor to read or write main memory at a time.

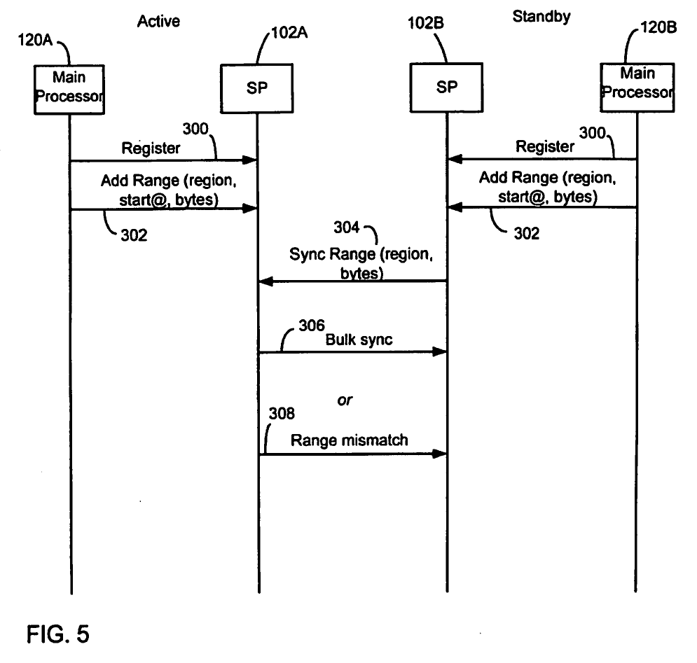

FIG. 5 is a signaling diagram illustrating the initialization process of the system. When the system is initialized, processes executing on the main processor, which wish to checkpoint, register with the SP. In addition, adds regions of memory that it wishes to sync with its respective process on the other processor are also sent to the SP. Specifically, each main processor sends a register message 300 to its SP. Next, each main processor sends an Add Range message 302 providing the regions of memory that it wishes to sync. In the communication process, whenever the standby subsystem 202 adds a range of addresses to sync with the active subsystem 200, the standby SP 102B sends a Sync Range message 304 to the active SP 102A. The active SP 102A checks the information in the request, region and length, for example as configured on the system. This implies that the identification of the regions and their attributes must be coordinated between the active and standby subsystems prior to initialization time. This is generally a system configuration on the main processor. Once the request is verified, the active SP 102A reads the data for that range from main memory and generates the messages, either as a bulk sync message 306 (for a bulk sync) or a Range mismatch message 308 for the standby SP to store the data into its main memory. In another embodiment, the Range mismatch message may be two messages, an offset mismatch message and a region mismatch message. Any memory location changed by the main processor during this time will show up in the FIFO queue 108 as detected by the MWD 106 and processed after the bulk sync has been completed.

During normal operations, there is a sequence of events for the active subsystem 200. First, when the MWD 106A detects write to main memory, it compares the address of the write to its database of address ranges. If there is a match, the MWD 106A copies the address and data from the write to the FIFO queue 108A. The SP 102A reads the FIFO queue 108A and translates the address to a range (region) and offset. The SP 102A then builds a message to send to the standby SP 102B with this information along with the data for that address. The SP 102A then transmits the information to the standby SP 102B.

During normal operations, there is also a sequence of events for the standby subsystem 202. The standby SP 102B receives the checkpoint message from the active SP 102A and decodes the message. The SP 102B translates the region and base address to a physical address in the main memory on the standby subsystem 202. The SP 102B then writes the data in the message to the physical address that it calculated from the checkpoint message.

Bulk sync is performed whenever the standby SP 102B registers with its peer active SP 102A a range (region) of addresses to checkpoint. This can occur in two cases. One is when the subsystems are initializing and the other is when a single process registers its need to checkpoint its state information. It is always the standby SP 102B that triggers the bulk sync.

If a failure on the active subsystem 202 is detected, several actions occur. The MWD 106A is disabled to prevent any corrupt writes entering the FIFO queue 108A and being transmitted to the standby subsystem 202. The active SP 102A plays out the changes in the FIFO after the failure. When the playout finishes, a switchover to the standby subsystem 202 is conducted. The active subsystem 200 then sends a message to the standby SP 102B that it should assume the active position.

In the preferred embodiment of the present invention, should the failed subsystem be repaired or replaced, it can be initialized and begin syncing with the now active subsystem. After the bulk syncs have been completed, the standby side is fully prepared to assume the role of an active subsystem in case of another failure.

The present invention may utilize many different types of interconnection mechanisms and still remain in the scope of the present invention. For example, interconnects, such as shared memory and sockets may be utilized.

For interprocessor communications between the SPs, there are several messages which may be exchanged. A Sync range message provides a request to sync a range of main memory addresses. A Bulk sync message sends all data within a range to the standby SP 102B. An Incremental Sync Message sends the data from a write change on the active processor. An End of life message informs the standby SP 102B to take the active role.

Between the main processor 120 and the SP 102, there are also several messages which may be exchanged. A Register message 300 registers with the SP a process. No further work happens. A Deregister message deregisters a process from the SP. Upon receipt of this Deregister message, the SP also deletes the addresses from the MWD 106 for that process so that it no longer snoops for those addresses. In addition, an Add Range message adds a range of addresses to the MWD. A Delete range message deletes a range of addresses from the MWD.

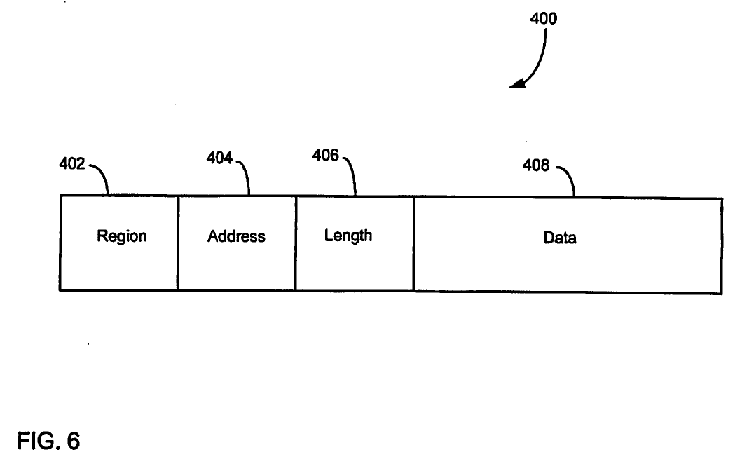

The contents of the write data block that is transmitted between the active and standby processors must include several items. FIG. 6 illustrates the contents of a memory write block 400 in the preferred embodiment of the present invention. The memory write block includes a region 402 of the data. The standby SP 102B uses this region to find the base address of the data. An Offset address 404 of the data is added to the base address determined from the region to calculate the physical address in main memory where the data is to be stored. A length 406 of the data and the data 408 are also within the memory write block 400.

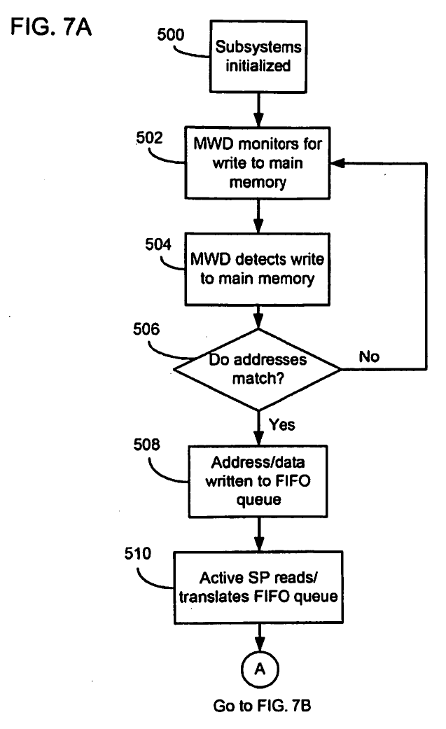

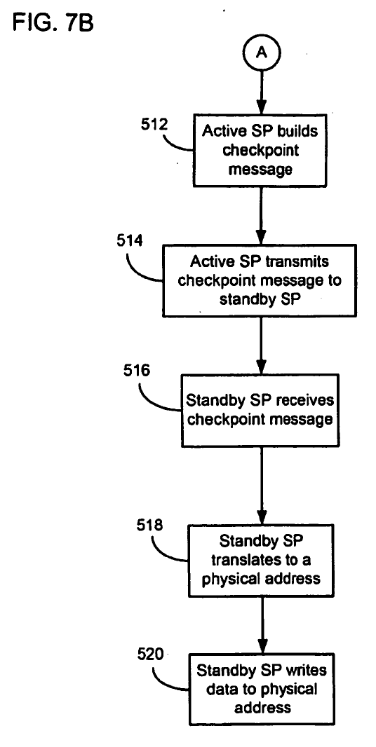

FIGS. 7A and 7B are flow charts illustrating the steps of independently and dynamically checkpointing a routing system according to the teachings of the present invention. With reference to FIGS. 3-7, the method will now be explained. The method starts in step 500 where the subsystems 200 and 202 are initialized. When the subsystems are initialized, processes executing on the main processor are registered with the SP with add regions of memory that it wishes to sync with its respective process on the other processor. Specifically, each main processor sends a register message 300 to its SP. In addition, during the initialization process, each main processor sends an Add Range message 302 providing the regions of memory that it wishes to sync. In the communication process, whenever the standby subsystem 202 adds a range of addresses to sync with the active subsystem 200, the standby SP 102B sends a Sync Range message 304 to the active SP 102A. The active SP 102A checks the information in the request, region and length, for example as configured on the system. In step 502, the MWD 106A monitors for write to main memory actions. Next, in step 504, the MWD 106A of the active subsystem detects write to main memory. In step 506, the MWD then compares the address of the write to its database of address ranges provided during the initialization step. In step 506, it is determined if there is a match between the addresses. If there is not a match, the MWD continues to monitor for any write to main memory changes in step 502.

However, in step 506, if it is determined that the addresses of the write to main memory and the provided address ranges of step 500 match, the address and data are written to the FIFO queue 108A in step 508. Next, in step 510, the SP 102A reads the FIFO queue and translates the address to a range (region) and offset. In step 512, the SP 102A builds a checkpoint message to send to the standby SP 102B with this information along with the data for that address as shown in FIG. 6. Next, in step 514, the SP 102A transmits the checkpoint message to the standby SP 102B.

The method proceeds to step 516 where the SP 102B receives the checkpoint message and decodes the message. In step 518, the SP 102B translates the region and base address to a physical address in the main memory 122B of the standby subsystem 202. Next, in step 520, the SP 102B writes the data in the checkpoint message to the physical address that it calculated from the checkpoint message in step 518.

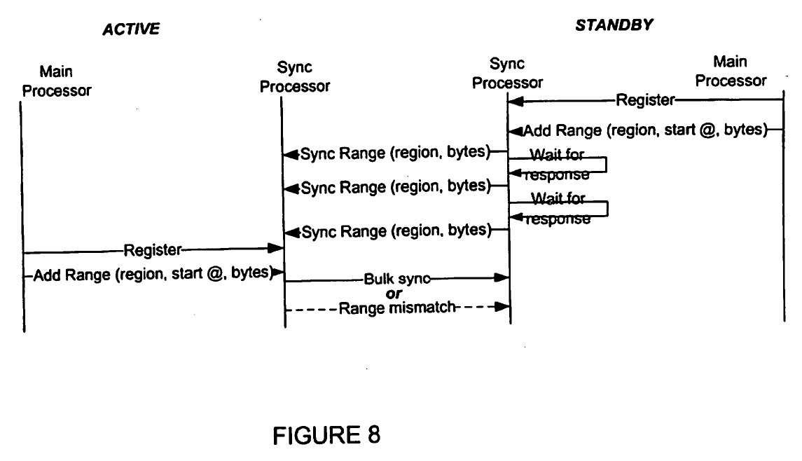

In another embodiment, during an initialization time, the standby subsystem may start prior to the active subsystem. FIG. 8 is a signaling diagram illustrating the initialization process when the standby processor 120B starts prior to the active processor 120A in another embodiment of the present invention. In this embodiment, if the standby processor becomes operational before the active processor, there will be no answer to the “sync range” message. In this case, the standby processor preferably waits for a short period of time and re-transmits its “sync range” message. It should continue this procedure until the active processor responds with a “bulk sync” message or a “range mismatch” message. Referring to FIG. 8, the processor 120B sends a register message 600 to the SP 102B. In addition, the processor sends an Add Range message 602. Next, the SP 102B sends a Sync Range message 604 to the SP 102A. The SP 102B waits for a response 606, and then retransmits the Synch range message 604. When the active processor 120A starts operations, it sends a register message 610 and an Add Range message 612 to the SP 102A. In turn, the SP 102 sends a Bulk sync message 620 or a Range mismatch message 622 to the SP 102B.

The present invention has many advantages over existing synchronization systems. The present invention independently synchronizes written data on the active subsystem with the standby subsystem. This removes the burden of checkpointing state data from the application itself. Furthermore, the data may be checked by an independent process to ensure the accuracy of the data on the standby subsystem, thereby increasing its reliability. This ensures that all active processor memory changes are synchronized with the standby processor memory system, even when the active processor fails, thus increasing the reliability of the synchronization mechanism. In addition, the addresses of the memory changes are virtual addresses. The sections of memory that are being modified on the standby can be at a different location in memory than that of the active processor memory. The present invention dynamically configures the application that is desired to be maintained in state synchronization with the standby application. This reduces the amount of unnecessary checkpointed data. After the failed processor recovers, is fixed or replaced, the newly appointed active processor preferably synchronizes the current state of the applications that are configured for synchronization. This process is performed independently of the main processor, leaving it available to process routing/forwarding requests.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A method of synchronizing a routing system having an active subsystem actively processing within the routing system and a standby subsystem, the method comprising the steps of:
specifying an address or range of addresses of data to be synchronized within the routing system;
detecting a write to main memory of the active subsystem;
comparing an address of the detected write to main memory of the active subsystem with the specified address or range of addresses;
storing the address and data of the detected write to main memory in a First In First Out (FIFO) queue of the active subsystem if the address of the detected write to main memory matches the specified address or range of addresses;
sending the address and data of the detected write to main memory to the standby subsystem; and
writing the sent address and data of the detected write to main memory to the standby system.

2. The method according to claim 1 wherein the step of detecting a write to main memory is conducted by a memory write detector in the active subsystem.

3. The method according to claim 1 further comprising the steps of:
reading the address and data stored in the FIFO queue;
translating the address and data into a checkpoint message; and
wherein the step of sending the address and data includes sending the checkpoint message with the address and data of the detected write to main memory to the standby system.

4. The method according to claim 3 wherein the checkpoint message includes a region, address and data associated with the write to main memory stored in the FIFO queue.

5. The method according to claim 4 further comprising the step of translating the region and address in the checkpoint message to a physical address in a main memory of the standby subsystem.

6. The method according to claim 1 wherein the step of specifying an address or range of addresses of data includes adding a range of addresses by the standby subsystem to the active subsystem.

7. The method according to claim 6 wherein the step of adding a range of addresses by the standby subsystem to the active subsystem includes re-transmitting the range of addresses by the standby subsystem to the active subsystem if the active subsystem does not respond to the standby subsystem during an initialization phase.

8. The method according to claim 1 wherein the step of specifying an address or range of addresses of data includes specifying regions of memory within an active processor of the active subsystem.

9. The method according to claim 1 further comprising the step of, upon detecting a failure in the active subsystem, switching active control of the routing system from the active subsystem to the standby subsystem.

10. The method according to claim 9 wherein the step of switching active control includes disabling a memory write detector in the active subsystem.

11. The method according to claim 9 wherein the step of switching active control includes switching from an active synchronization processor in the active subsystem to a standby synchronization processor in the standby subsystem.

12. The method according to claim 9 wherein the former active subsystem is replaced or repaired and used as a new standby subsystem.

13. A system for synchronizing a routing system, the system comprising:
an active subsystem actively processing within the routing system;
a standby subsystem providing a backup for the active subsystem;
wherein the active subsystem includes:
means for storing a specified address or range of addresses of data to be synchronized within the routing system;
means for detecting a write to main memory of the active subsystem;
means for comparing an address of the detected write to main memory of the active subsystem with the specified address or range of addresses;
means for storing the address and data of the detected write to main memory in a First In First Out (FIFO) queue of the active subsystem if the address of the detected write to main memory matches the specified address or range of addresses;
means for sending the address and data of the detected write to main memory to the standby subsystem; and
wherein the standby subsystem includes means for writing the sent address and data of the detected write to main memory in the standby system.

14. The system according to claim 13 wherein the means for detecting a write to main memory is a memory write detector.

15. The system according to claim 13 further comprising a synchronization processor having:
means for reading the address and data stored in the FIFO queue;
means for translating the address and data into a checkpoint message; and
wherein the means for sending the address and data includes the synchronization processor sending the checkpoint message with the address and data of the detected write to main memory to the standby system.

16. The system according to claim 15 wherein the checkpoint message includes a region, address and data associated with the write to main memory stored in the FIFO queue.

17. The system according to claim 16 further comprising a standby synchronization processor in the standby system having means for translating the region and address in the checkpoint message to a physical address in a main memory of the standby subsystem.

18. The system according to claim 13 wherein the means for storing the specified address or range of addresses of data includes means for adding a range of addresses by the standby subsystem to the active subsystem.

19. The method according to claim 18 wherein the means for adding a range of addresses by the standby subsystem to the active subsystem includes means for re-transmitting the range of addresses by the standby subsystem to the active subsystem if the active subsystem does not respond to the standby subsystem during an initialization phase.

20. The system according to claim 13 wherein the means for storing the specified address or range of addresses of data includes specifying regions of memory within an active processor of the active subsystem.

21. The system according to claim 13 further comprising means for switching active control of the routing system from the active subsystem to the standby subsystem in response to a detected failure of the active subsystem.

22. The system according to claim 21 wherein the means for switching active control includes means for disabling a memory write detector in the active subsystem.

23. The system according to claim 21 wherein the means for switching active control includes means for switching from an active synchronization processor in the active subsystem to a standby synchronization processor in the standby subsystem.

24. The system according to claim 21 wherein the former active subsystem is replaced or repaired and used as a new standby subsystem.

25. An active subsystem of a routing system for synchronizing the active subsystem with a standby subsystem backing up the active subsystem in a routing system, the active subsystem comprising:
means for storing a specified address or range of addresses of data to be synchronized within the routing system;
means for detecting a write to main memory of the active subsystem;
means for comparing an address of the detected write to main memory of the active subsystem with the specified address or range of addresses;
means for storing the address and data of the detected write to main memory in a First In First Out (FIFO) queue of the active subsystem if the address of the detected write to main memory matches the specified address or range of addresses; and
means for sending the address and data of the detected write to main memory to the standby subsystem.

26. The active subsystem according to claim 25 wherein the means for detecting a write to main memory is a memory write detector.

27. The active subsystem according to claim 25 wherein the means for sending the address and data is an active synchronization processor having:
means for reading the address and data stored in the FIFO queue;
means for translating the address and data into a checkpoint message; and
means for sending the checkpoint message with the address and data of the detected write to main memory to the standby system.

28. The active subsystem according to claim 25 wherein the active synchronization process includes means for switching active control of the routing system from the active subsystem to the standby subsystem in response to a detected failure of the active subsystem.

29. The active subsystem according to claim 28 wherein the means for switching active control includes means for disabling a memory write detector in the active subsystem.
